(19) United States
(12) Patent Application Publication
(10) Pub. No.: US 2012/0295247 A1
(43) Pub. Date: Nov. 22, 2012

(54) PORCINE SEMINAL MATERIAL COMPOSITION FOR ARTIFICIAL INSEMINATION OF SOWS

(75) Inventor: Luc Liegeois, Raimbeaucourt (FR)

(73) Assignee: GENES DIFFUSION, Douai (FR)

(21) Appl. No.: 13/515,976

(22) PCT Filed: Dec. 6, 2010
(86) PCT No.: PCT/FR10/52620

§ 371 Date: Jun. 14, 2012

(30) Foreign Application Priority Data
Dec. 14, 2009 (FR) 0958906

(51) Int. Cl. A01N 1/02

(52) U.S. Cl. 435/2

(57) ABSTRACT

A porcine seminal material composition intended for artificial insemination of sows includes capsules containing a suspension made of porcine seminal material coated with a bi-valent or tri-valent ion alginate film, wherein the porcine spermatozoon concentration within the porcine seminal material suspension present in the capsules is between 900 and 1500 million spermatozoa per milliliter.

### OBJECT OF THE INVENTION

The present invention relates to a composition containing porcine seminal material intended for artificial insemination of sows, as well as to the method for obtaining this composition.

The present invention also relates to a kit including one or several flasks with said composition or elements of said composition and an insemination means (probe) able to carry out artificial insemination of a sow with this composition.

### TECHNOLOGICAL BACKGROUND AND STATE OF THE ART AT THE BASIS OF THE INVENTION

Artificial insemination technology has been used for insemination of several domestic species for many years.

For porcine artificial insemination, most bred females are conducted in <<gangs>> in order to group interventions and to concentrate them in order to reduce the observation and operating time on the animals. Physiologically, weaning of piglets generates resumption of the cycle of the sow which comes back into heat 5 days on average after weaning. It is therefore sufficient to wean together the piglets, generally on Wednesdays and Thursdays, so that 10% of the sows come on heat Sundays, 50% on Mondays, 30% on Tuesdays and the last 10% the remainder of the week. The average duration of the heat period is spread from 24 to 72 hours. Heats of the first sows generally occur for longer periods. During these occurrences, the breeder may inseminate according to his/her habits every 12 or 24 hours with many variable time periods.

In order to cover the females, the breeders use on average per cycle 2.6 doses each containing 2.2 thousand million spermatozoa. In order to reduce the number of interventions while ensuring good availability of the spermatozoon in the genital tract of the female, means have to be applied for obtaining insemination for a long period.

The concept of encapsulating sperm with deferred release over time was described in patent EP 0 922 451 and is based on the use of capsules comprising a liquid core containing a suspension of seminal porcine material as well as a biodegradable and/or biocompatible polymer, the whole being coated with a film consisting in an alginate and with a bi- or tri-valent metal, optionally cross-linked. Usually, the alginate film of bivalent metals is selected from calcium, strontium and zinc alginate. Alginates of trivalent metals are preferably selected from those of aluminum, iron or chromium.

A large number of polysaccharides such as alginate, chitosans, pectins, pectins, carrageenans, xanthans have the particularity of forming hydrogels spontaneously by physical or chemical modification, for example by a modification of the pH, of the temperature or by adding a suitable counter-ion. Sodium alginate is for example a natural polyanionic polysaccharide of the cell wall of a brown alga (such as Marcycystis pyrifera, Laminaria digitata, Ascophyllum nodosum) which accounts for up to 40% of the dry weight of the alga.

The alginate consists of a mixture of manuronic acid and of guluronic acid which is soluble in water, but forms a gel in the presence of di- or trivalent cations. Compounds such as EDTA have the action of also capturing these ions and of destructuring the obtained gels.

Porcine sperm is very sensitive to stress induced by a sudden thermal shock as well as by a change in osmotic pressure or pH and its motility is rapidly altered by changes in the medium. This alteration may occur by evolution towards apoptosis of the spermatozoa which follows the capacitation phenomenon. This phenomenon is viewed by the appearance of agglutinates, the ultimate phase before death of the cells.

### OBJECTS OF THE INVENTION

The object of the present invention is to provide a novel composition including porcine seminal material intended for artificial insemination of sows and which does not have the drawbacks of the state of the art.

The object of the present invention is also to provide a method for obtaining such a composition, as well as a kit including one or several flasks containing said composition or containing the elements of said composition and a means (probe) for inseminating sows with this composition.

A particular object of the present invention aims at providing such a composition characterized by reduced toxicity or reduced stress towards spermatozoa present in a seminal (encapsulated and/or free) material while allowing efficient and prolonged administration of spermatozoa to a sow.

### CHARACTERISTIC ELEMENTS OF THE INVENTION

A first object of the invention relates to a composition of porcine seminal material intended for artificial insemination of sows and comprising capsules incorporating porcine seminal material, coated with an alginate film which does not have the drawbacks of the state of the art.

In particular, in the composition of the invention, the concentration of spermatozoa in the porcine seminal material present in the capsules is comprised between 900 million and 2,000 million spermatozoa per milliliter.

Further, the composition of the porcine seminal material of the invention may include a free fraction of porcine seminal material, i.e. a free fraction of porcine seminal material not present in capsules and which is not coated with a film of alginate (of a bi- or tri-valent ion). In this case, the concentration of spermatozoa present in the free fraction of the porcine seminal material includes between 25 million and 35 million spermatozoa per milliliter.

This means that the composition of the invention includes between 1 and 3,000 million (preferably between 1.5 and 2.5 thousand million) of encapsulated spermatozoa and/or between 1.5 and 2 thousand million (preferably between 1.5 and 2.5 thousand million) of free spermatozoa, i.e. non-encapsulated spermatozoa.

Preferably, in the composition of the invention, the selected ion is barium, but may also be another metal ion, preferably bivalent, such as a calcium ion or another earth alkaline ion.

Another aspect of the present invention relates to a method for obtaining the composition of the invention which essentially comprises the following steps:
a porcine seminal material is collected and subject to one or several steps for extraction at more than 50%, preferably more than 65%, still preferably more than 75% of the seminal plasma initially present in this porcine seminal material and for collecting the porcine seminal material enriched with spermatozoa following this extraction.
said porcine seminal material is then enriched in spermatozoa and added with 2% to 8% of a bi- or tri-valent ion, preferably a barium ion, is suspended and added dropwise, to a solution of an alginate of a monovalent metal ion, preferably sodium ion, in order to form capsules coating said seminal material enriched with spermatozoa.
said obtained capsules are then collected (in order to form an encapsulated fraction of porcine seminal material) and preferably mixed with a free fraction of porcine seminal material.

In the method of the invention, the steps for extracting the porcine seminal plasma include or consist in one or several steps for centrifugation of the porcine seminal material followed by one or several steps for removing the seminal plasma present in the supernatant of the medium subject to centrifugation and for collecting the porcine seminal material enriched with spermatozoa.

Another object of the invention relates to an insemination kit including one or several flasks containing the composition or the elements of the porcine seminal material composition according to the invention, in particular the free fractions and/or the encapsulated captions as well as an insemination means able to carry out artificial insemination of a sow with this composition and optionally a flask containing a diluting agent of this composition, in particular a diluting agent of the free fraction of porcine seminal material, such as the product Gedil®.

### DETAILED DESCRIPTION OF THE INVENTION

The inventors have unexpectedly discovered that the encapsulation of porcine seminal material as described in patent EP 0 922 451 induced <<toxicity>> (or <<stress>>) for porcine spermatozoa present in the obtained capsules or for free (non-encapsulated) spermatozoa, but put into contact with these capsules.

In particular, the inventors have unexpectedly discovered that at least two products present in these capsules are capable of generating this <<toxicity>> (or <<stress>>) affecting the properties of porcine spermatozoa. The inventors have demonstrated for the first time that a barium solution, in particular the barium ions present in the solution, as well as sodium alginate or polymerized alginate present in these capsules alter the essential properties (such as the motility) of porcine spermatozoa.

These detrimental effects on porcine spermatozoa are demonstrated in Tables 1 and 2 which show the result of a <<toxicity>> (or <<stress>>) test obtained by adding barium chloride (BaCl₂ at 5 or 10%) on free semen and show after two days a significant reduction in the motility of the spermatozoa. In order to obtain efficient fertilization, more than 50% of the spermatozoa have to be <<motile>> (i.e. having an individual displacement velocity of more than 20 micrometers per second).

TABLE 1
Effect of 5 or 10% barium chloride (BaCl₂) on the
motility of spermatozoa present in free semen.

| SAMPLES | 5% BaCl₂ | 10% BaCl₂ |
|---|---|---|
| Boar 1 CG0533 | 68-19 | 58-12 |
| Boar 2 CG6558 | 45-20 | 29-07 |
| Boar 3 Lwc Derby | 40-10 | 24-05 |
| Boar 4 DB2125 | 69-30 | 40-15 |
| Boar 5 PF2182 | 50-26 | 48-28 |

Both values (X-Y) mentioned in this table are the result of two measurements: The first value (X) over 100 means that X spermatozoa over 100 have a motility of more than 20 micrometers per second (X so-called [symbol] motile [symbol] spermatozoa) The second value (Y) over 100 means that Y of these same 100 spermatozoa have a same displacement velocity greater than or equal to 80 micrometers per second (Y so-called [symbol] progressive [symbol] spermatozoa).

TABLE 2
Effect of 2% barium chloride (BaCl₂) on the motility
of spermatozoa present in free semen.

| | |
|---|---|
| GEDIL CONTROL | GEDIL + 2% BaCl₂ |

| SAMPLES | J + 1 | J + 3 | J + 1 | J + 3 |
|---|---|---|---|---|
| Boar 1 | 53-23 | 51-19 | 54-29 | 45-23 |
| Boar 2 | 85-34 | 87-42 | 82-46 | 78-50 |
| Boar 3 | 85-38 | 82-43 | 83-54 | 80-40 |
| Boar 4 | 86-27 | 84-25 | 84-46 | 79-45 |
| Boar 5 | 80-20 | 77-24 | 77-34 | 73-22 |
| Boar 6 | 75-19 | 72-23 | 57-28 | 60-23 |
| Boar 7 | 79-33 | 84-34 | 79-45 | 84-45 |
| Boar 8 | 75-23 | 75-48 | 70-45 | 73-52 |
| Boar 9 | 68-11 | 60-11 | 63-17 | 64-17 |
| Boar 10 | 80-41 | 77-43 | Uninterpretable | 60-34 |

Table 3 shows the effect of the number of capsules (beads) having a size comprised between 50 μm and 8 mm, on the motility of spermatozoa after 1 and 3 days. Gedil® is a diluting agent consisting of a biological medium favorable to preservation of spermatozoa. The inventors also diluted the spermatozoa in media other than Gedil® and also observed a <<toxicity>> (or <<stress>>) induced by addition of BaCl₂.

TABLE 3
Effect of the number of beads (capsules) on free semen:

| | | GEDIL + 4 | | GEDIL + 20 | |
|---|---|---|---|---|---|
| | GEDIL | beads per tube | | beads per tube | |
| SAMPLES | CONTROL | J + 1 | J + 3 | J + 1 | J + 3 |
| Boar 1 | 73-15 | 69-26 | 66-09 | 51-16 | 51-05 |
| Boar 2 | 81-45 | 77-52 | 73-13 | 50-26 | 58-10 |
| Boar 3 | 82-39 | 75-49 | 71-15 | 47-20 | 60-11 |
| Boar 4 | 85-41 | 82-36 | 83-18 | 41-07 | 51-08 |
| Boar 5 | 57-18 | 64-30 | 69-10 | 55-17 | 57-05 |
| Boar 6 | 67-25 | 70-33 | 80-17 | 55-12 | 57-05 |
| Boar 7 | 86-36 | 86-37 | 82-12 | 51-12 | 69-09 |
| Boar 8 | 78-41 | 85-49 | 87-14 | 56-31 | 60-13 |
| Boar 9 | 72-15 | 61-15 | 70-08 | 49-18 | 62-09 |
| Boar 10 | 78-41 | 66-37 | 74-07 | 68-23 | 59-03 |

Note:
Motility of the spermatozoa is affected: the obtained movements are fluid with the addition of 4 beads (capsules) and the movements are jerky with the addition of 20 beads (capsules). The inventors also diluted the spermatozoa in media other than Gedil ® and also observed toxicity proportional to the number of added beads (capsules).

In order to reduce the harmful effect of these products (toxic), the inventors obtained a reduction in the global proportion of these toxic elements in the composition of the invention, by achieving concentration of the porcine seminal liquid and of the spermatozoa present in these capsules. This operation is obtained by removing a large proportion of seminal plasma present in this porcine seminal material to be encapsulated. Consequently, the concentration of porcine spermatozoa in the capsules increases significantly, which leads to reducing the amount of these capsules and of these (toxic) elements from these capsules in the final composition obtained consisting of encapsulated spermatozoa and of free spermatozoa (i.e. non-encapsulated spermatozoa), and optionally of diluting agent.

The present invention will be described in detail in the examples below shown as a non-limiting illustration of the invention.

### Example 1

Porcine semen is collected and arrives in the laboratory at a temperature of the order of 33° C. to 35° C. It is measured as for its concentration, its volume and its color, and then introduced into a centrifuge rotating at about 800 g, for a duration of about 10 minutes. By this centrifugation, about ⅔ of the supernatant (containing seminal plasma) are removed and measured as to their concentration by substraction in order to determine the amount of remaining spermatozoa, ⅓ of the preserved volume containing the essential of the spermatozoa, is intended to be encapsulated.

The spermatozoa concentration within the seminal material intended to be encapsulated may also be accomplished by other techniques well known to one skilled in the art, such as sedimentation (for example upon a temperature shift of about 17° C.) or by filtration on a membrane (for example a membrane of about 0.1 μm) so as to remove or reduce a significant proportion (i.e. more than 50%, preferably more than 65%, still preferably more than 75% or more than 85%) of seminal plasma.

This fraction is mixed beforehand with a barium solution (addition of an aqueous (solution) saturated with barium chloride—215 g of barium chloride in powder per liter—in order to obtain a final concentration of barium ions of 25 mmol/L), and then injected dropwise into a solution of sodium alginate with stirring (sodium alginate in solution; 0.01% to 1% by weight per volume). It is thus possible to inject about 500 ml of sperm added with barium chloride in a bath of 20 liters of sodium alginate.

The capsules (beads) are instantaneously formed in contact with the periphery of the drop and thickened during several tens of minutes. The spermatic material encapsulated in the sodium alginate film (gel), and comprising more than 900 million spermatozoa per milliliter, is then separated by simple filtration. After washing, the capsules (beads) are recovered in a separation basket and then quantified in volume. Next, they are mixed with a fraction of diluted free seminal material (comprising about 33 million spermatozoa per milliliter). This mixture of a free fraction combined with an encapsulated fraction allows fertilization of a sow, if the ovulation of the sow is located within the few following hours and thus allows fertilization to be obtained on a longer period, by postponed release of the encapsulated spermatozoa later on. The obtained composition is then injected into a probe, for which the inlet and outlet orifices have been adapted for letting through the capsules (a diameter of about 0.8 cm).

This <<encapsulated fraction>> represents a volume of capsules containing about 1.5 to 2.5 thousand million spermatozoa.

Alternatively, the encapsulated fraction which represents a volume of capsules beads containing from about 1.5 to about 2.5 thousand million spermatozoa is mixed with the free fraction, diluted and containing between about 1.5 thousand million and about 2.5 thousand million spermatozoa present in a suitable diluting agent. Both of these fractions are globally mixed with stirring.

The ovulation was introduced by weaning without adding any hormones. Detection of heat in sows is measured twice a day from the 3^{rd} day after weaning. Insemination is carried out after detection of ovulation. A possible gestational state measured by echography and the whole of the data are measured. On the whole, the inventors notice an increase in the number of gestations in sows fertilized with the composition of the invention (where the spermatozoa were concentrated before encapsulation) as compared with sows fertilized by a composition without any concentration, and this for a same number of (both free and encapsulated) spermatozoa.

1. A porcine seminal material composition intended for artificial insemination of sows and comprising capsules incorporating porcine seminal material, coated with a film of an alginate of a bi- or tri-valent ion, wherein the concentration of spermatozoa of the porcine seminal material present in the capsules, is comprised between 900 million and 2,000 million spermatozoa per milliliter.

2. The porcine seminal material composition according to claim 1, further comprising a free fraction of porcine seminal material.

3. The composition according to claim 2, wherein the concentration of spermatozoa present in the free fraction of these porcine seminal material includes between 25 million and 35 million spermatozoa per milliliter.

4. The composition according to claim 2, which includes:
between 1 and 3 thousand million encapsulated spermatozoa, and
between 1 and 2.5 thousand million free spermatozoa (non-encapsulated).

5-8. (canceled)

9. The composition according to claim 4, which includes between 1.5 and 2.5 thousand million encapsulated spermatozoa and between 1.5 and 2 thousand million free spermatozoa (non-encapsulated).

10. The composition according to claim 1, wherein the bi-valent ion is selected from the group consisting in Ba²⁺ and Ca²⁺ ions.

11. A method for obtaining the composition according to claim 1, comprising the following steps:
a collected porcine seminal material is subject to one or several steps for extraction by more than 50% of the seminal plasma present in the porcine seminal material,
said porcine seminal material enriched with spermatozoa and added with between 2% and 8% of a bi- or tri-valent ion suspended in a suitable diluent and added dropwise to a solution of sodium alginate in order to form capsules coating said seminal material enriched with spermatozoa,
the obtained capsules are collected, and
the collected capsules are optionally mixed with a free fraction of the porcine seminal material.

12. The method according to claim 11, wherein a collected porcine seminal material is subject to one or several steps for extraction by more than 75% of the seminal plasma present in the porcine seminal material.

13. The method according to claim 11, wherein the step(s) for extracting the porcine seminal plasma include(s) one or several steps for centrifugation of the porcine seminal material followed by removal of the seminal plasma present in the obtained supernatant and for collecting the porcine seminal material enriched with spermatozoa.

14. An insemination kit including one or several flasks containing the composition or the elements of the composition of porcine seminal material according to claim 1 and an insemination means able to carry out artificial insemination of a sow with this composition.

15. The insemination kit of claim 14 which further comprises a flask containing a diluting agent for the composition.
